(19) United States
(12) Patent Application Publication
(10) Pub. No.: US 2008/0100226 A1
(43) Pub. Date: May 1, 2008

(54) Control Method and Apparatus for Improving the Efficacy of Fluorescent Lamps

(76) Inventor: Charles Trushell, Manhattan, KS (US)

Correspondence Address: PHILIPS INTELLECTUAL PROPERTY & STANDARDS, P.O. BOX 3001, BRIARCLIFF MANOR, NY, 10510, US

(21) Appl. No.: 10/562,284

(22) PCT Filed: Jun. 21, 2004
(86) PCT No.: PCT/IB04/50950

§ 371 Date: Dec. 22, 2005

Related U.S. Application Data
(60) Provisional application No. 60/482,716, filed on Jun. 27, 2003.

(51) Int. Cl. H05B 39/04; H05B 41/39

(52) U.S. Cl. 315/157

(57) ABSTRACT

A fluorescent lamp arrangement has a fluorescent lamp (100), a thermal insulation (102) disposed with the fluorescent lamp for preventing heat from escaping from the lamp, a sensor (110) for detecting the amount of light generated by the lamp and a circuit (104) responsive to the sensor which controls the amount of electrical power which is supplied to the fluorescent lamp in accordance with the sensor output and which optimizes the amount of light which is produced by the fluorescent lamp for the amount of electrical power consumed.

The present invention relates to a control method and apparatus for improving the efficacy of fluorescent lamps.

In the drawings:

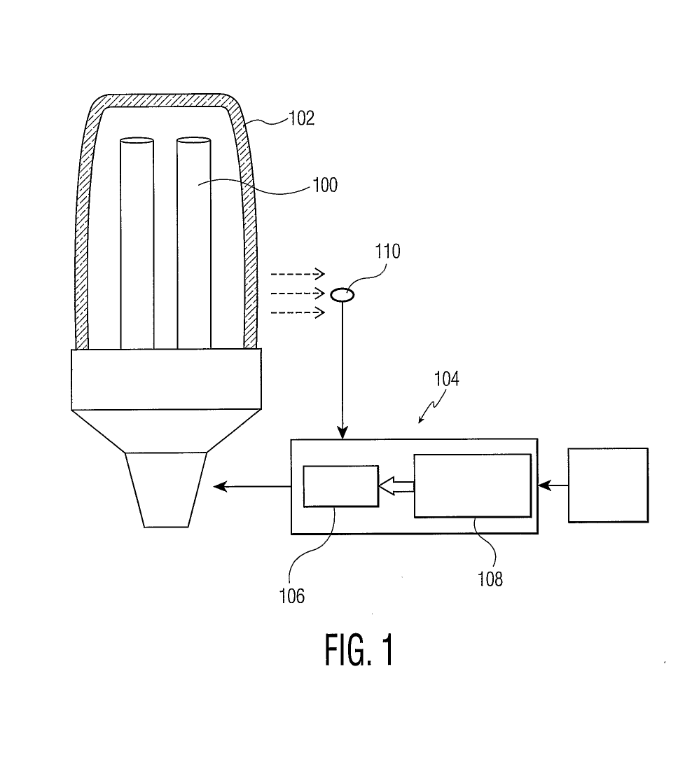

FIG. 1 is a schematic representation of a first embodiment of the present invention as applied to a conventional type of fluorescent lamp which is enclosed in a thermally insulative enclosure to prevent loss of heat and wherein the control circuitry which implements the dimming control is located externally of the lamp.

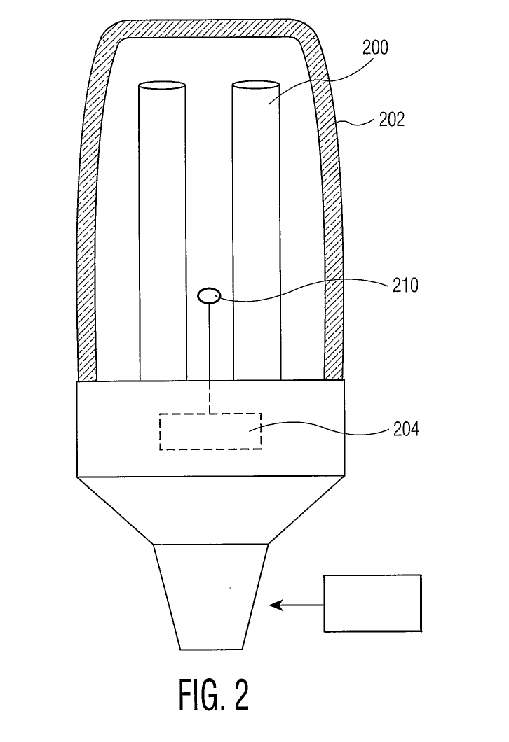

FIG. 2 is a schematic representation of an embodiment wherein the fluorescent lamp has been adapted so that the control circuitry which implements the necessary control is incorporated in the body of the lamp along with the blast and other circuits.

The efficiency of converting electrical energy into UV radiation (which ultimately produces visible light) depends heavily on the concentration of mercury vapor inside an operating lamp. The concentration of mercury vapor, in turn, is very dependent on the temperature of the glass bulb enclosing the operating arc. Due to inherent inefficiencies in the conversion of electrical energy to visible light some amount of heat is produced. This has the effect of raising the bulb wall temperature.

Since the amount of heat lost from the lamp due to convection/radiation depends on temperature, the operating lamp reaches an equilibrium temperature wherein there is balance between the amount of heat generated and the amount of heat which is lost. This temperature depends on electrical power applied and factors that influence heat transfer from the bulb. For instance, if the lamp has a surrounding sleeve, is encapsulated in plastic (i.e. ‘Shattersheild’) or is operated in a poorly designed or situated luminaire, the bulb wall will reach a higher temperature than normal.

The light output of a fluorescent lamp attains a maximum at a particular bulb wall temperature. In other words, fluorescence lamps have an optimum operating temperature. Since this temperature depends on the pressure of other gases in the lamp interior it is an intrinsic feature of different lamp designs. In most lamps this temperature is about 40° C. (104° F.). The glass bulb does not exhibit a uniform temperature when the lamp is operating so at thermal equilibrium the “coldest spot” on the bulb establishes the concentration of mercury in the operating arc. If the concentration of mercury vapor is too high or too low the light output of the lamp is less than what it would be at the optimum temperature.

In accordance with the embodiments of the invention, active dimming of fluorescent lamp-based lighting systems is employed and the heat generated by the lamps is intentionally prevented from escaping.

It will be appreciated that, in the absence of control circuitry the lamp temperature would increase to a level where the ‘cold spot’ of the lamp would be above the optimum temperature for that particular lamp. This would of course reduce the efficacy of the lamp and therefore result in less light being produced by the power which is supplied thereto. The thermal insulation of the lamp is achieved by using any one or combination of know techniques.

With the control circuitry according to the embodiment of the invention, the active dimming causes a reduction in power delivered to the system (based on luminous flux) which reduces the temperature of the lamp toward that at which maximum light output is achieved. This results in the ‘cold spot’ of the lamp being maintained at the optimum temperature for light output. The reduction in power required to achieve this optimum situation results in an increase in lamp efficacy.

More specifically, the embodiments of the invention in effect, heat the lamps so that the temperature is increased. This can be done by insulating the lamps so that as little heat as possible is allowed to escape. The embodiments then utilizes this otherwise waste heat, which is a natural consequence of inefficiencies in producing light in fluorescent lamps, to enable an increase in lamp (and system) efficacy.

Merely by way of example, FIG. 1 shows a fluorescent lamp 100 which is provided with a thermally insulative type enclosure 102. This enclosure can be selected to have a low IR (infrared) transmittivity and thermal conduction while sufficiently transparent to allow for efficient illumination. In this example, the enclosure can be made of polycarbonate or have a polycarbonate glaze on the interior. Alternatively or in addition thereto, the interior of the enclosure can be evacuated or filled with a gas which inhibits the loss of the heat generated by the fluorescent lamp, to the external atmosphere. For example, gases such as argon or krypton could be used. Filling the interior of the enclosure can be filled with carbon dioxide is also within the purview of the embodiment.

It will be appreciated at this point, that this type of lamp and is being illustrated merely by way of example and that the invention is not limited to this specific type of lamp configuration/arrangement. It should be also noted that the thermal insulative techniques which can be used to limit the amount of heat which is permitted to escape from the lamp, is not limited to enclosures and that other techniques may be used. For example, glazing the outer walls of the gas filled portions of the fluorescent lamp with an IR reflective material such as polycarbonate of other forms of heat reflective films can also be used.

A source of alternating current, such as conventional household supply is connected to a control circuit 104. This circuit includes active controller and dimmer functions. These are denoted by the functional blocks 106, 108.

A light sensor 110 is arranged so as to be responsive to the amount of light which is produced by the lamp. This sensor 110 can take the form of a photodiode, phototransistor of the like type of photo sensitive device which generates an output which varies with the amount of light which is received.

The output of this sensor 110 is applied to the control circuit and is, in accordance with this embodiment of the invention, used to automatically modify the amount of power which is supplied to the lamp by the dimmer in small imperceptible increments until such time as the sensor output reaches a maximum and the current which is consumed is at its lowest level for the detected amount of light.

Examples of the type of circuit which can be utilized for this automatic control can be found in U.S. Pat. No. 4,394,603 issued on Jul. 19, 1983 in the name of Widmayer, U.S. Pat. No. 4,482,844 issued on Nov. 13, 1984 in the name of Schweer et al. and U.S. Pat. No. 5,742,131 issued on Apr. 21, 1998 in the name of Spout et al. The disclosure of these documents is hereby incorporated by reference.

The above mentioned patents disclose fluorescent lamp dimmer controls which are responsive to ambient light. However, it is deemed well within the purview of a person of skill in the art of controlling the amount of electrical power supplied to a fluorescent lamp that using the sensor 110 to detect only the light from the fluorescent lamp and therefore be unresponsive to ambient light, and therefore control the amount of electrical power supplied to the lamp 100 in a manner wherein the optimally maximum light generation for the optimally minimum power input, can be readily achieved. Accordingly, no further disclosure will be given for brevity.

FIG. 2 depicts an embodiment wherein the insulation, sensor and control circuit are incorporated into a single unit as different from the arrangement which is shown in FIG. 1 wherein the sensor and control circuit are disposed outboard of the fluorescent lamp per se. In FIG. 2, elements corresponding those denoted by the numerals 100, 102, 104, etc., are designated by 200, 202, 204, etc.

The outboard disposition of the sensor 110 and circuit 104 in the FIG. 1 arrangement, is suited to situations wherein a group of lamps are used in close proximity and a single light sensitive sensor can be used for control all of the group. This control can be extended to a large number of lamps wherein the sensor is oriented toward the lamps so as to be responsive to only the light produced by the lamps and therefore enable a single circuit arrangement be used to control the current which is supplied to all of the lamps. In other words, all the lamps in a large room can be controlled by a single sensor arrangement which is adapted (such as by suitable lenses, shielding or the like) to detect the amount of light which is being produced by the plurality of lamps.

Heretofore, the number of lamps in a fixture is limited by considerations of heat transfer so that the “cold spot” of each lamp does not greatly exceed the point where the lamp loses efficiency. Previously, cold temperature applications required special, more expensive HO (high output) and VHO (very high output) lamps.

However, with the embodiments of the invention, if enough lamps are put in a fixture inexpensive lamps can be used in these applications instead of the more expensive HO or VHO types. In fact, in this arrangement the fixture can be used to insulate the lamps or used further insulate lamps which are already provided with their own individual insulation to prevent loss of heat and/or induce the heat to accumulate in the fixture and achieve the heat loss which is used to improve the efficacy of the lamps.

The embodiments of the invention allow for good luminaire design. For a given number of lamps of a certain wattage, the luminaire must accommodate the heat generated in order to maintain the lamps at the optimum temperature. If a luminaire is underdesigned so that it contains too many lamps (i.e. to achieve higher light intensities) the lamps are bound to get too hot and the light output and efficacy are compromised. Thus good luminaire design is heavily constrained by the heat generation of lamps. Similarly, if a lamp has a sleeve or is encapsulated in plastic it will also tend to operate above the optimum temperature with the same consequence. The embodiments of the invention, of course, obviate this problem.

In addition to achieving the optimum light generation for the amount of current used, the embodiments of the invention tend to improve the longevity of the lamps in that for a given lamp, with the insulation, the amount of power can actually be reduced and thus enable the lamp to operate at less than its normally rated wattage.

Although the invention has been disclosed with reference to only a limited number of embodiments, it will be appreciated that if lamps, sleeves, encapsulations and luminaires are designed in such a way as to generate excessive heat they can be used in a circuit, as above, to operate with reduced power while still producing the expected light output (viz., are operating with increased efficacy). This permits, among many other things, smaller, cheaper luminaires with higher luminous flux (more lamps per unit area). HO and VHO lamps could be used in compact applications, CFLs (compact fluorescent lights) could be operated without amalgams and the annoying run-up properties.

Further, while the embodiments of the invention have focussed on insulative techniques for inducing self-heating of the lamps, it is within the scope of the invention to heat the lamps using some external source of heat. This source can be a source of waste heat should one be conveniently close to the lamps disposition

The scope of the invention is limited only by the appended claims.

1. A fluorescent lamp arrangement comprising:
a fluorescent lamp;
a source of heat disposed with fluorescent lamp for elevating the temperature of the fluorescent lamp;
a sensor for detecting the amount of light generated by the lamp; and
a circuit responsive to the sensor which controls the amount of electrical power that is supplied to the fluorescent lamp in accordance with the sensor output and which optimizes the amount to light that is produced by the fluorescent lamp for the amount of electrical power consumed.

2. A fluorescent lamp arrangement as set forth in claim 1, wherein the source of heat comprises thermal insulation disposed with the fluorescent lamp to prevent heat which is generated by the fluorescent lamp from escaping from the fluorescent lamp.

3. A fluorescent lamp arrangement as set forth in claim 2, wherein the thermal insulation comprises a thermal insulating medium disposed about at least the light emitting portion of the fluorescent lamp.

4. A fluorescent lamp arrangement as set forth in claim 2, wherein the thermal insulation comprises an enclosure.

5. A fluorescent lamp arrangement as set forth in claim 4, wherein the enclosure is adapted to be thermally insulative.

6. A fluorescent lamp arrangement as set forth in claim 4, wherein the interior of the enclosure is evacuated.

7. A fluorescent lamp arrangement as set forth in claim 4, wherein the interior of the enclosure is filled with a gas having thermally insulative properties.

8. A fluorescent lamp arrangement as set forth in claim 2, wherein the thermal insulation comprises a glazing of a thermally insulative material on at least the light emitting portions of the fluorescent lamp.

9. A method of increasing fluorescent lamp illumination efficiency comprising:
heating the fluorescent lamp;
sensing light emitted from the fluorescent lamp and producing a signal indicative of an amount of light emitted thereof; and
controlling the amount of electrical power supplied to the fluorescent lamp in response to the sensed level of illumination to adjust a temperature of the fluorescent lamp temperature toward a value at which the amount of light emitted by the fluorescent lamp is optimized.

10. A method as set forth in claim 9, wherein the heating of the fluorescent lamp comprises preventing heat loss from the fluorescent lamp and using heat which is produced by the lamp to heat itself.

11. A method as set forth in claim 10, wherein the step of preventing loss of heat comprises enclosing the fluorescent lamp in an enclosure which attenuates loss of heat therethough.

12. A method as set forth in claim 11, wherein the step of preventing heat loss comprises enclosing the fluorescent lamp in an enclosure and evacuating air from a space in the enclosure.

13. A method as set forth in claim 10, wherein the step of preventing heat loss comprises providing the enclosure with a heat reflective layer.

14. A method as set forth in claim 13, wherein the heat reflective layer is made of polycarbonate.

15. A method as set forth in claim 10, wherein the step of preventing heat loss comprises enclosing the fluorescent lamp in an enclosure and filling a space within the enclosure with a medium which exhibits low heat transmission characteristics.
